(19) United States
(12) Patent Application Publication
(10) Pub. No.: US 2004/0099690 A1
(43) Pub. Date: May 27, 2004

(54) Apparatus and methods of removing elastomer from a container

(76) Inventors: Shawn Elliott, Edison, NJ (US); Kenneth Kanca, Parlin, NJ (US); Donald Siwicki, Whitehouse Station, NJ (US); Edward Zuromski, Bridgewater, NJ (US)

Correspondence Address: BELL, BOYD & LLOYD LLC, P. O. BOX 1135, CHICAGO, IL, 60690-1135, US

(21) Appl. No.: 10/303,303

(22) Filed: Nov. 25, 2002

(51) Int. Cl. B67D 5/64

(52) U.S. Cl. 222/166

(57) ABSTRACT

Apparatus and methods for emptying containers containing an elastomer are disclosed. The system includes a holding device that receives a container containing the elastomer. Connected to the holding device is a rotation assembly that allows the holding device to be rotated about an axis of rotation for assisting in emptying the container held by the holding device. Additionally, the holding device allows a bag within the container containing elastomer to be secured such that the elastomer may be easily separated from the bag.

### BACKGROUND OF THE INVENTION

The present invention relates to apparatus and methods for emptying a product from a container, and, more particularly, to removing an elastomer from a barrel container.

In an industry such as chewing gum manufacturing, an elastomer such as polyisobutylene, which is used to make chewing gum, is typically shipped in cardboard cylinders. In order to extract the elastomer from the cardboard cylinder, the cardboard is cut open and the elastomer dumped out into carts, which, in turn, are used to transport the elastomer to a hopper or other receptacle for processing. Additionally, the cardboard cylinders typically include a food-grade plastic liner that contains the elastomer within the cardboard. When the cardboard cylinders are cut and emptied there is difficulty in separating the bag from the elastomer since the elastomer is sticky and adheres to the bag. As a result, the emptying process is costly and time consuming because the cylinders cannot be reused and the liner bag must be separated from the elastomer after removal from the cardboard cylinder.

### SUMMARY OF THE INVENTION

According to an embodiment, a container manipulation system is disclosed having a holding device configured to receive a container and hold the container by applying pressure to a portion of the container. Additionally, the system includes a rotation assembly connected to the holding device and movable about an axis of rotation so as to allow the holding device to move from one position to at least one other position.

In another embodiment the holding device is configured to removably receive the container.

In another embodiment, the holding device includes two portions connected by a hinge mechanism where the two portions are rotatable with respect to one another to allow the container to be removably received between the two portions.

In another embodiment, the holding device includes a one-piece member having two ends that are selectively brought together to hold the container.

In yet another embodiment, the container includes a barrel containing a plastic bag and an elastomer within the plastic bag.

According to another embodiment, the holding device is configured to retain a portion of the plastic bag between the holding device and the container.

According to another embodiment, the rotation assembly includes a positional indexing device configured to selectively rotate the holding device.

In another embodiment, the rotation apparatus includes a shaft to connect the holding device to the rotation assembly.

In yet another embodiment, a container emptying system for containers containing an elastomer within a bag within the container is disclosed. The system comprising includes a clamping device configured to receive a container and hold the container by applying pressure to a portion of the container. A shaft is connected to the clamping device. Also, a rotation assembly is include that receives the shaft and is configured to allow the shaft to move about an axis of rotation so as to allow the clamping device to move from one position to at least one other position.

According to another embodiment, the clamping device includes two portions connected by a hinge mechanism where the two portions are rotatable with respect to one another to allow the container to be received between the two portions.

In another embodiment, the container comprises a barrel containing a plastic bag and an elastomer within the plastic bag.

In another embodiment, the clamping device is configured to retain a portion of the plastic bag between the clamping device and container.

In another embodiment, the rotation assembly includes a positional indexing device configured to selectively allow the rotation assembly to rotate the clamping device.

In another embodiment, the rotation assembly includes a shaft to connect the holding device to the rotation assembly.

In another embodiment, a container manipulation system for use in conveying and emptying a product within a container is disclosed. The system includes a pair of holding devices each configured to receive a container and hold the container by applying pressure to a portion of the container. A shaft connecting the pair of hold devices is further included. Additionally, the system includes a rotation device through which the shaft passes and configured to retain the shaft and allow the shaft to rotate within the rotation device about an axis of rotation to selectively permit the pair of holding devices to move from one position to at least one other position.

In another embodiment, the rotation device further includes an indexing assembly to selectively permit rotation of the shaft the holding devices to move from the one position to the at least one other position.

In another embodiment, the shaft further includes a shaft coupling affixed to the shaft configured to interface with the indexing assembly.

In another embodiment, the indexing assembly further includes a bar member to interface with the shaft coupling in order to prevent the shaft from rotating and an operating mechanism for selectively causing the bar member to engage with the shaft coupling.

In yet another embodiment a method of emptying containers of a product is disclosed. The method includes opening an end portion of a container containing a bag having the product contained therein. An end portion of the bag is pulled out of the end portion of the container and around a portion of an outside surface of the container. The container is placed in a clamping device configured to hold the container. The container is clamped with the end portion of the bag disposed between the clamping device and the container to secure the bag. The clamping device is rotated to empty the product from the bag.

In another embodiment of a method, the product comprises an elastomer.

In yet another embodiment of a method, clamping the container includes engaging pull-action clamps to apply a pressure to the container.

In another embodiment of a method, the method further includes engaging an indexing assembly that selectively permits the clamping device to rotate.

In still another embodiment of a method, rotating the clamping assembly further includes disengaging the indexing assembly to permit the clamping device to rotate.

Additional features and advantages of the present invention are described in, and will be apparent from, the following Detailed Description of the Presently Preferred Examples and the figures.

### BRIEF DESCRIPTION OF THE FIGURES

FIG. 1 illustrates a perspective view of an example of a system for emptying elastomer from containers.

FIG. 2 illustrates a plan view of an example of a clamping assembly used with the system of FIG. 1.

FIG. 3 shows a plan view illustrating how a container is placed in the clamping assembly of FIG. 2.

FIG. 4 illustrates a perspective view of a clamping assembly and barrel container as used in the example system of FIG. 1.

FIG. 5 illustrates a perspective view of a clamped container that shows securing of a top portion of a plastic bag within the container holding a product.

FIG. 6 illustrates a perspective view of an example of a one piece clamping assembly for use with the system of FIG. 1.

FIG. 7 illustrates a side view of a shaft used in the system of FIG. 1.

FIG. 8 illustrates a side view of a collar assembly used in the system of FIG. 1.

FIG. 9 illustrates a cross-section view of the shaft and collar assembly when assembled together.

FIG. 10 illustrates a side view of an indexing and securing system employed with the shaft and collar assemblies of FIGS. 7-9 as utilized in the system of FIG. 1.

FIG. 11 shows a perspective view illustrating a rotated position of the clamping assemblies for the system of FIG. 1.

### DETAILED DESCRIPTION OF THE PRESENTLY PREFERRED EXAMPLES

The present invention provides systems and devices for manipulating containers so that they can be emptied.

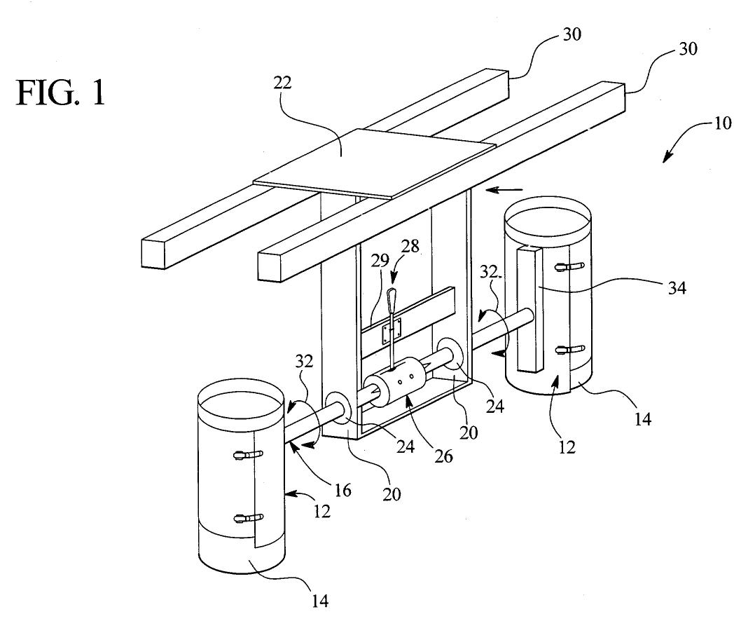

Referring to the figures, FIG. 1 illustrates an example of a system 10 that may be employed for manipulation of containers containing a particular product. In particular, the system 10 may be employed for emptying elastomer from cardboard cylinders directly into a hopper or some other processing receptacle.

The system 10 includes one or more clamping or holding devices 12 that are used to receive and hold product containers or barrels 14. As shown, the holding or clamping devices 12 are connected to a rotation assembly including a shaft 16, which passes through and is supported by a frame assembly 18.

The frame assembly 18 includes vertical brackets 20 that are attached to a top plate 22. Each vertical bracket 20 includes a bore hole and flange assembly 24 through which the shaft 16 passes. The bore hole and flange assembly 24 allow the shaft 16 to rotate therein about an axis of rotation. A shaft coupling 26 is attached to the shaft 10 to control the rotation movement of the shaft 16 and will be discussed later with respect to FIGS. 7-9.

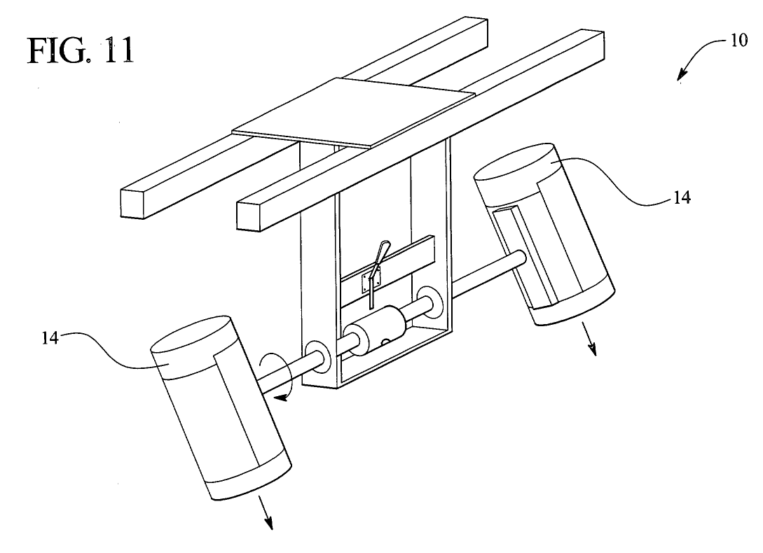

Associated with the shaft coupling 26 is an indexing assembly 28 attached to a mounting bracket 29, which is, in turn, attached at both ends to respective ones of the vertical brackets 20. The indexing assembly 28 serves to control the rotation of the shaft 16 by interfacing with the shaft coupling 26 and will also be discussed later with respect to FIG. 10.

In order to transport the entire assembly 10, the top plate 22 attaches to one or more lifting beams 30, which assist in allowing other processing equipment to lift and move the system 10.

The system 10 illustrated in FIG. 1, as mentioned previously, holds one or more containers 14 for the purpose of emptying the containers 14. The system 10 allows the containers to be emptied without cutting or destroying the containers 14 such that they may be reused. As illustrated by direction arrows 32, the shaft 16 rotates about its longitudinal axis. Since the clamping devices 12 are fixedly attached to the shaft 16, rotation of the shaft 16 causes the clamping devices 12 to also rotate about the same axis that the same degree of rotation as is illustrated in FIG. 11. Thus, the product, i.e., the elastomer, may be easily emptied by gravity from the containers 12.

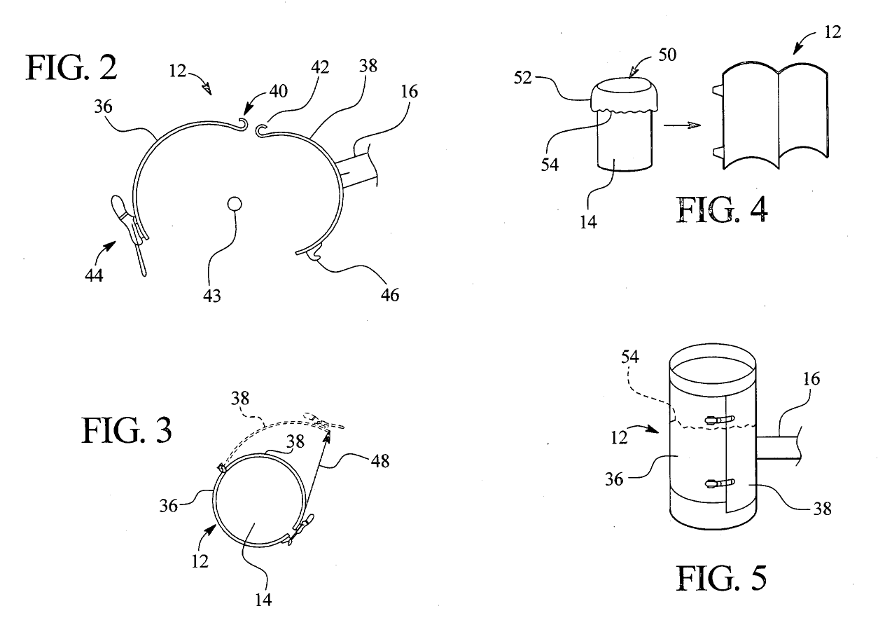

FIG. 2 illustrates a plan view of an example of the clamping device 12. The device 12 includes a first arcuate member 36 having a hinge assembly 40 at one end. An opposing second member 38, which is attached to the shaft 16, is included with a hinge assembly 42 at an end of the second arcuate member 38. The hinge assemblies 40 and 42 are complimentary such that the two arcuate members 36, 38 may be hingedly joined together with a hinge pin (not shown). Hence, the two members 36 and 38 of the clamping apparatus 12 are rotatable with respect to one another about the hinge mechanism comprised of the hinge assemblies 40 and 42. It is noted that the two members 36, 38 may be joined together by any suitable hinge-type means known in the art whereby the members may be moved with respect to one another to allow insertion of a container into an inner portion 43 of the clamping apparatus 12. Such means may include different types of hinges as well as flexible straps. Alternatively, the two members 36, 38 may be constructed from a one-piece unitary having a flexible hinge portion formed therein and thereby defining the first and second arcuate members.

Attached to one of the arcuate members (e.g., arcuate member 36 in the example of FIG. 2) is the handle portion 44 of a pull action clamp, such as those manufactured by DE-STA-CO, for example. An opposing hook portion 46 of the pull action clamp is mounted on the second arcuate member 38. In order to close the clamping apparatus 12, the handle portion 44 of the pull action clamp may be moved to allow a clamping pull bar, which is a part of the handle portion 44, to be placed over the opposing hook portion 46. When the handle portion is then pressed down the latch clamp provides a powerful closing force as well as positive holding for the pull action clamp to hold the arcuate members 36 and 38 together. It is noted that in the present example, two pull action clamps are illustrated. This number is merely exemplary and any number of clamps may be utilized dependent on the size of the clamping apparatus 12 and the desired holding force to be applied by the holding apparatus 12 on a container enclosed therein. Additionally, it is noted that the use of pull action clamps for closing the clamping apparatus 12 is merely exemplary and any known means for fastening may be employed.

FIG. 3 illustrates a top view of a container 14 placed within the clamping apparatus 12. As shown, the container 14 may be placed within the clamping apparatus 12 when the second arcuate member 38 is rotated relative to the first acuate member 36 (the second arcuate member being illustrated by dashed lines for the open position). The members 36, 38 are rotated relative to one another to create an opening distance 48 between ends of the arcuate portions 36 and 38 sufficient to allow the container 14 to be placed within the clamping apparatus 12. Once the container 14 is placed, the arcuate members 36, 38 may be moved relative to one another to a closed position and subsequently latched with the pull action clamps. The inside circumference of the clamping apparatus 12 may be selected such that it is slightly less than the outside circumference of a container 14 placed therein. Accordingly, the closing force due to the action of the pull action clamps will effect a pressure on the container 14 such that it will be positively retained within the clamping apparatus 12 regardless of the degree of rotation of the entire clamping apparatus 12.

As discussed previously, in the chewing gum industry cardboard cylinders containing elastomer typically include a food grade plastic bag inside the cylinder, which, in turn, contains the elastomer product. In operation, the disclosed system 10 may be utilized to retain the plastic bag within the cardboard cylinder when emptying the elastomer product. As illustrated in FIG. 4, a container 14 includes a top opening 50. When the container 14 is opened the plastic bag 52 may be pulled out of the opening 50 and around at least a portion of the outside surface of the container 14 such that an end portion 54 of the bag lies concentric around the outside surface of the container 14. The container 14 may then be placed into the clamping apparatus 12 and secured.

As illustrated in FIG. 5, a container having the plastic bag 52 pulled around the outside of the container 14 is illustrated in a fastened position within the clamping apparatus 12. As illustrated, the end portion 54 of the bag 52 is secured between the inside surface of the clamping apparatus 12 and the outside surface of the container 14. Thus, when the apparatus 12 is inverted for emptying the elastomer product, the clamping apparatus 12 retains the plastic bag 52 allowing only the elastomer product to be emptied into a hopper or other receptacle.

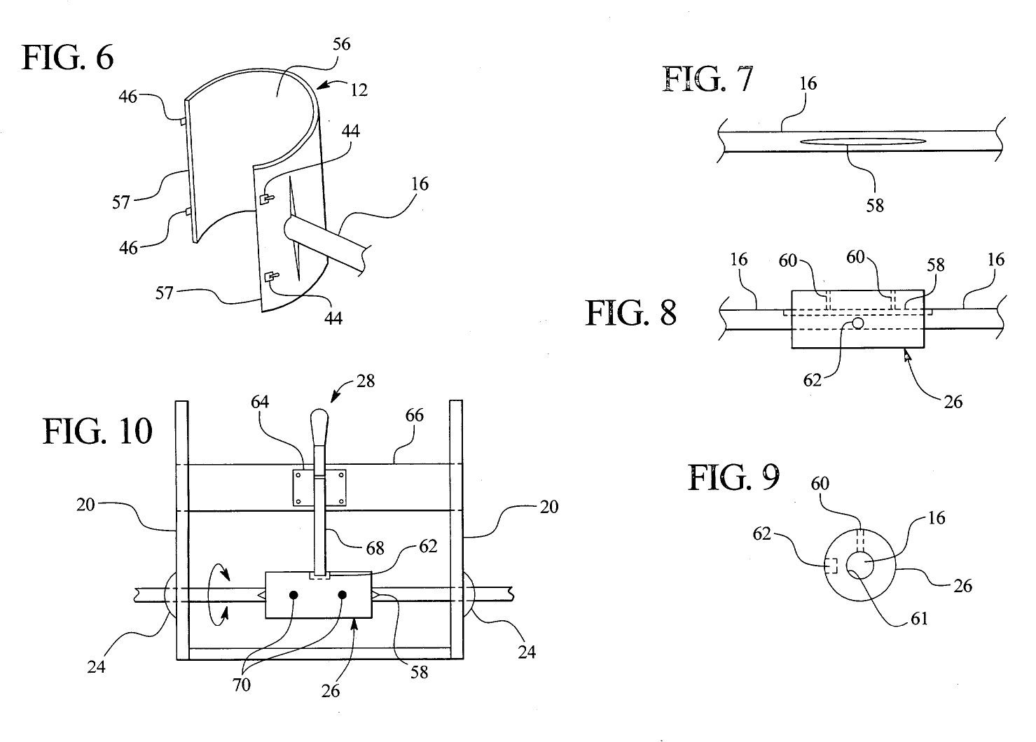

An alternative construction of the clamping apparatus 12 is illustrated in FIG. 6. As shown, the apparatus 12 is comprised of a single, flexible member 56. The member 56 is flexible to allow the ends 57 of the member to be separated thereby allowing a container to be placed within the apparatus 12. Additionally, each of the ends 57 includes respective portions of one or more pull action clamps or similar fastening devices for clamping the one piece member 56 around a container by holding the ends 57 in proximity to one another. As illustrated in FIG. 6, the defined shape of the one-piece member 56 is cylindrical, but may be of any shape or configuration to accommodate various shaped containers.

In order to allow control over the rotation of the shaft 16, the system 10 may also include the shaft coupling 26 along with the indexing assembly 28. To accommodate an exemplary shaft coupling, the shaft 16 includes a groove or keyway slot 58 as illustrated in FIG. 7. The shaft coupling 26 is placed around the shaft 16 as illustrated in FIG. 8 and includes one or more keyway access holes 60 which are drilled through the shaft coupling 26 all the way through to a center bore 61 as shown in the cross-section of FIG. 9. The shaft coupling 26 also includes a indexing bore hole 62 that is configured to interface with the indexing assembly 28, which will be described below with respect to FIG. 10. The keyway access holes 60 may include a tapped thread to enable setscrews to be screwed therein in order to interface with the keyway slot 58. The setscrews therefore serve to secure the shaft coupling 26 to the shaft 16 such that the shaft coupling 26 is held in place and will not rotate with respect to the shaft 16.

FIG. 10 illustrates the interaction between the indexing assembly 28 and the shaft coupling 26 to afford control of the shaft rotation. As shown, the indexing assembly 28 includes a locking clamp 64 that is mounted to a mounting bracket 66, which is connected to each of the vertical brackets 20 of the frame assembly. The locking clamp 64 is attached to a locking bar 68, which is positioned and shaped to interface with the indexing bore hole 62 of the shaft coupling 26. The action of the locking clamp 64 causes the locking bar 68 to travel vertically in the example shown to engage or disengage with the indexing bore hole 62. The locking clamp 64 may comprise a pull action type clamp similar to those utilized with the clamping apparatus 12. Notwithstanding, other types of assemblies may be utilized that effect vertical movement of the locking bar 68 to engage or disengage with the indexing bore hole 62. The shaft coupling 26 is also shown with a pair of setscrews 70 in FIG. 10.

In operation, the indexing assembly 28 in conjunction with the shaft coupling 26 allows the shaft 16 to be locked in a particular position thereby preventing rotation of the shaft 16. Typically, this locked position of the shaft 16 would correspond to an upright position of the clamping devices 12 attached to each end of the shaft 16. In this position, containers 14 may be placed and clamped into the clamping devices 12. Once the containers 14 are fastened, the locking clamp 64 may be operated to disengage the locking bar 68 from the indexing bore hole 62 thereby permitting rotation of the shaft 16 about the longitudinal axis of rotation through the shaft flanges 24. This rotation allows the containers 14 to be inverted as illustrated in FIG. 11 for emptying of the elastomer product from the containers 14.

The foregoing description is merely exemplary and other examples may be envisioned. For example, other means of controlling the rotation of the shaft 16 may be employed such as a rachet, a gear, a pulley or any other means to effect control of the rotation of a shaft about its longitudinal axis. Additionally, other shapes for the clamping assemblies may be envisoned dependent upon the particular shape of a product barrel or container. Moreover, although the disclosed examples illustrate two clamping assemblies, either one or multiple clamping assemblies could be utilized with the disclosed system.

It should be understood that various changes and modifications to the presently preferred embodiments described herein will be apparent to those skilled in the art. Such changes and modifications can be made without departing from the spirit and scope of the teachings of the present invention and without diminishing their intended advantages. It is therefore intended that such changes and modifications be covered by the appended claims.

What is claimed is:

1. A container manipulation system comprising:
a holding device configured to receive a container and hold the container by applying pressure to a portion of the container; and
a rotation assembly connected to the holding device and movable about an axis of rotation so as to allow the holding device to move from one position to at least one other position.

2. A system as defined in claim 1, wherein the holding device is configured to removably receive the container.

3. A system as defined in claim 2, wherein the holding device comprises two portions connected by a hinge mechanism where the two portions are rotatable with respect to one another to allow the container to be removably received between the two portions.

4. A system as defined in claim 2, wherein the holding device comprises a one-piece member having two ends that are selectively brought together to hold the container.

5. A system as defined in claim 1, wherein the container comprises a barrel containing a plastic bag and an elastomer within the plastic bag.

6. A system as defined in claim 4, wherein the holding device is configured to retain a portion of the plastic bag between the holding device and the container.

7. A system as defined in claim 1, wherein the rotation assembly includes a positional indexing device configured to selectively rotate the holding device.

8. A system as defined in claim 1, wherein the rotation apparatus includes a shaft to connect the holding device to the rotation assembly.

9. A container emptying system for containers containing an elastomer within a bag within the container, the system comprising:
a clamping device configured to receive a container and hold the container by applying pressure to a portion of the container;
a shaft connected to the clamping device; and
a rotation assembly that receives the shaft and is configured to allow the shaft to move about an axis of rotation so as to allow the clamping device to move from one position to at least one other position.

10. A system as defined in claim 9, wherein the clamping device comprises two portions connected by a hinge mechanism where the two portions are rotatable with respect to one another to allow the container to be received between the two portions.

11. A system as defined in claim 9, wherein the container comprises a barrel containing a plastic bag and an elastomer within the plastic bag.

12. A system as defined in claim 9, wherein the clamping device is configured to retain a portion of the plastic bag between the clamping device and container.

13. A system as defined in claim 9, wherein the rotation assembly includes a positional indexing device configured to selectively allow the rotation assembly to rotate the clamping device.

14. A system as defined in claim 9, wherein the rotation assembly includes a shaft to connect the holding device to the rotation assembly.

15. For use in conveying and emptying a product within a container, a container manipulation system comprising:
a pair of holding devices each configured to receive a container and hold the container by applying pressure to a portion of the container;
a shaft connecting the pair of hold devices; and
a rotation device through which the shaft passes and configured to retain the shaft and allow the shaft to rotate within the rotation device about an axis of rotation to selectively permit the pair of holding devices to move from one position to at least one other position.

16. A system as defined in claim 15, wherein the rotation device further comprises an indexing assembly to selectively permit rotation of the shaft the holding devices to move from the one position to the at least one other position.

17. A system as defined in claim 16, wherein the shaft further comprises a shaft coupling affixed to the shaft configured to interface with the indexing assembly.

18. A system as defined in claim 17, wherein the indexing assembly further includes a bar member to interface with the shaft coupling in order to prevent the shaft from rotating and a operating mechanism for selectively causing the bar member to engage with the shaft coupling.

19. A method of emptying containers with a product comprising:
opening an end portion of a container containing a bag having the product contained therein;
pulling an end portion of the bag out of the end portion of the container and around a portion of an outside surface of the container;
placing the container in a clamping device configured to hold the container;
clamping the container with the end portion of the bag disposed between the clamping device and the container to secure the bag; and
rotating the clamping device to empty the product from the bag.

20. A method as defined in claim 19, wherein the product comprises an elastomer.

21. A method as defined in claim 19, wherein clamping the container includes engaging pull-action clamps to apply a pressure to the container.

22. A method as defined in claim 19, wherein the method further comprises:
engaging an indexing assembly that selectively permits the clamping device to rotate.

23. A method as defined in claim 22, wherein rotating the clamping assembly further comprises disengaging the indexing assembly to permit the clamping device to rotate.
